(19) United States
(12) Patent Application Publication
(10) Pub. No.: US 2008/0277470 A1
(43) Pub. Date: Nov. 13, 2008

(54) Voting authentication and administration

(75) Inventors: David Wesley Gallaher, Idaho Springs, CO (US); John Loyd, Denver, CO (US); Stephen Peter O'Brien, Denver, CO (US); Robert Warren Woodward, JR., Boulder, CO (US)

Correspondence Address: MCCARTER & ENGLISH, LLP, FOUR GATEWAY CENTER, 100 MULBERRY STREET, NEWARK, NJ, 07102, US

(73) Assignee: New Plateau, LLC

(21) Appl. No.: 11/801,708

(22) Filed: May 10, 2007

(51) Int. Cl. G07C 13/00

(52) U.S. Cl. 235/386

(57) ABSTRACT

A device, method and system for voting are disclosed herein. The exemplary voting device may be comprised of a paper ballot unique to each voter, an ink pen which also houses an optical scanning device, multiple redundant electronic storage media devices whereupon cast votes and other information are recorded, and a voting management system used by voters to validate their selections and by poll workers and election judges to authenticate the ballot and resolve voting booth issues such as spoiled ballots. The device may facilitate the casting of votes and ensure their secure and accurate tallying.

### TECHNICAL FIELD

The present invention relates to voting/polling processes and, more particularly relates to security of votes, authentication of ballots and administration of voting/polling.

### BACKGROUND INFORMATION

The rapid shift in voting systems from mechanical to electronic in recent years was driven by both a perception that the old systems were somehow not satisfactory (especially in feeding the election night frenzy of the Media) and, quite possibly, particularly susceptible to fraud. Legislation, most notably at the Federal level, mandated substantial changes in the election process, from who is allowed to vote to special accommodations for special classes of voters. However, the new voting systems also have problems, both real and perceived, that have engendered a similar distrust in the voting process and continued concern that there is still the possibility of cheating in the election process.

Consider most of the newer electronic voting systems: The voter steps up to cast a vote on what is basically a personal computer (PC) running Microsoft Windows®. The PC collects the votes as the day goes on into data storage devices. After the polls close the storage modules are collected in a central point and/or their contents are downloaded to a central point for tabulation. Recounts are easy, simply push a button and the storage modules will dump exactly the results that were dumped the last time.

However, no count is actually made of the vote that was actually cast; what is counted or recounted is whatever data is in the storage modules. Absent a verifiably accurate method of, first, counting and, second, recounting actual votes, there is always the possibility that the software involved could either be designed or modified so as to produce, not an accurate tally of actual votes cast, but whatever results are desired.

The tabulation machines are often connected to a network that is connected to the Internet. This is so the manufacturer can access the machine through a virtual private network (VPN), or something similar, to provide support in preparation for and, if necessary, during an election. This may raise additional security issues. Procedural safeguards can be established that would absolutely prohibit the manufacturer from changing the software after the ballot has been locally tested and certified. It is reasonable to assume that most, if not all, jurisdictions have these safeguards, however there may be no proof that they are actually followed. Unless a forensic exam of every machine is performed, it may be impossible to determine whether the software in use during the ballot preparation and certification is the same software that was used in the actual election. Accordingly, a need exists for a device, method, and system for guaranteeing that the software used to register the voter's choices is identically the same software that the Election Authority approved for the election.

Microsoft Windows® has known security issues, yet almost all voting systems rely on it as the operating system for their voting platform. Also, because there are many, many machines used for voting, Microsoft Windows® security patches and updates are applied sporadically at best. Election officials are not likely to apply relatively untested Microsoft Windows® patches shortly before an election. Election officials have plenty of other problems to deal with before an election. Accordingly, a need exists for a device, method, and system for secured voting without placing additional burdens on election officials.

There is a great deal of pressure to add printers to each voting station. That way voters would be able to look at their vote; however, what is being looked at is NOT the voter's actual vote, but a printout of what the voting station asserts is the person's vote. In addition, voters cannot take the printout with them because it is secured at the polling site. Accordingly, a need exists for a device, method, and system for viewing and counting the actual piece of paper that the voter actually touched.

Accordingly, a need also exists for a device, method, and system for providing secure voting that accommodates various physical challenges faced by individuals.

### SUMMARY

The present invention is a novel device, system, and method for voting. The voting station may use a ballot having a unique dot, or other, pattern identifier. The unique dot, or other, pattern identifier may be a dot, or other, pattern that uniquely identifies the paper ballot. A digital pen at the voting station may have a physical marker, such as ink, for producing a physical mark on the ballot and an optical imaging device for recording the exact location of the marks made by the digital pen on the paper ballot. A display at the voting station may display an image of the paper ballot, along with an exact image of the marks, and their location on the ballot made by the voter. This display may be used as a confirmation image of the physically marked ballot so that voters will know how their votes have been cast. A digital pen docking station of the voting station, or wireless transmission capabilities built within the pen, may identify and transmit a status of the digital pen.

Embodiments of the present invention may incorporate one or more of the following features. In one embodiment, an administrator display shows the status of the digital pen. In another embodiment, the status of the digital pen is used to generate a status of the ballot. In another embodiment, a ballot status may be activated when an administrator activates the ballot and the digital pen is removed from the docking station. The ballot status is deactivated when the digital pen may be returned to the docking station. Or the ballot status is deactivated when the voter makes a mark on the ballot within a special box on the ballot indicating that they are done voting (when the digital pen detects that a mark has been made in this box, it will deactivate the ballot.) In yet another embodiment, a ballot status may be activated when an administrator activates the ballot by making a mark on the ballot within a special box on the ballot indicating that the ballot is now activated (when the digital pen detects that a mark has been made in this box by the administrator's pen, it will activate the ballot.) and the digital pen is removed from the docking station. The ballot status may be deactivated when the digital pen is not returned to the docking station, or is otherwise inactive, within a predetermined period of time.

The present invention is not intended to be limited to a system or method that must satisfy one or more of any stated objects or features of the invention. It is also important to note that the present invention is not limited to the exemplary or primary embodiments described herein. Modifications and substitutions by one of ordinary skill in the art are considered to be within the scope of the present invention, which is not to be limited except by the following claims.

### BRIEF DESCRIPTION OF THE DRAWING

These and other features and advantages of the present invention will be better understood by reading the following detailed description, taken together with the drawing wherein:

FIG. 1 is a system diagram of an exemplary voting system according to an exemplary embodiment of the present invention.

### DETAILED DESCRIPTION

The invention disclosed herein includes an electronic voting device and method. Embodiments of the present invention may be used to provide accurate, secure, and recountable election tallies during and after an election process. The votes may be stored in multiple, secure locations, in multiple formats, and from multiple sources. The voter actually casts his or her vote on a paper ballot, thus providing a paper trail of each individual vote. Along with the paper ballot, the vote may be displayed electronically, and the voter can identify it as either verified or not verified.

Embodiments of the present invention may enable the Election Authority to review any sequence of events during the voting process in order to verify the authenticity of a particular vote or votes that may be in question.

One embodiment of the present invention may include a ballot administration process. The process may begin with the voter arriving at the polling place and proceeding to the poll worker's desk. Then the poll worker may authenticate the voter and determine the appropriate ballot style. Once the poll worker retrieves the correct ballot, the ballot may be activated by the poll worker through the use of a poll worker digital pen. In one embodiment of the present invention, the poll worker may perform the ballot activation by retrieving the poll worker digital pen from the poll worker digital pen docking station and drawing a line across a special box or boxes printed on the ballot. The special box or boxes reserved for activating a ballot may be referred to as ballot authenticator location. The unique ballot identifier is recorded in the SecureVote system as being a valid ballot, and that the vote cast on said ballot should be counted. Once the ballot is activated, the poll worker may place the poll worker digital pen back into the poll worker digital pen docking station. To complete the activation sequence, the activated ballot may be placed in a privacy sleeve and then given to the voter, and the voter may receive instructions on the voting procedure from the poll worker.

Embodiments of the present invention may include the use of digital pens that function like a ball point pen and, additionally, contain a digital scanner or camera, an image processing system, and a communication unit. The digital pen contains memory and it records the exact shape and location of each and every mark made on the page by the voter. The digital pens may be used in conjunction with a ballot containing printed information identifying the voter's election. The ballot authenticator location on the ballot may contain a dot, or other, pattern that uniquely identifies the ballot. The location of the polling place and the ballot style may additionally be encrypted in the dot, or other, pattern in the ballot. The dot, or other, pattern on the ballot may be readable through the use of a digital scanner or camera in the pen. In an embodiment of the present invention, a digital pen may be used by a poll worker to activate a ballot containing a unique ballot authenticator. The digital pen may electronically record and store an exact copy of any pen strokes or marks made on the paper ballot by the voter, and the exact corresponding locations of those marks on the ballot. A processor external to the digital pen may be used to translate the exact marks and locations of the marks on each ballot into an image of the intended “vote” according to predefined code specific to the content and layout of each ballot style. The digital pen may contain a means of communication which may allow the electronically recorded data stored in the digital pen to be transferred from the pen to an external system. The data transfer may occur after each vote is cast or it may occur after a number of votes are cast.

An embodiment of the present invention may include a computer device at the poll worker's station. The device may be referred to as the poll worker console. The poll worker console may display real-time state information of the polling site including, but not limited to, information about activated ballots, the voter booths, the voter booths' digital pens, and any vote verification currently in progress. The information displayed regarding activated ballots may include the state of any ballot activated at the specific polling place. An embodiment of the present invention may display the status of each ballot as either, for example, activated, deactivated, cast, or “spoiled”. A ballot may become deactivated when a voter places the voter digital pen back into the voter digital pen docking station, or when the voter makes a mark on the ballot within a special box on the ballot indicating they are done voting (when the digital pen detects that a mark has been made in this box, it will deactivate the ballot.). A ballot may become “spoiled” under certain conditions, and a “spoiled” ballot may be immediately and irrevocably cast out as invalid. A new ballot may be obtained from a poll worker, and the voter may begin the voting process again. The information regarding the voter booths may display whether each voter booth is currently active (i.e. a voter is using the booth) or inactive (i.e. the booth is empty). The present invention may include a display identifying the status of the voter digital pen in each booth. The status may be either, for example, docked or undocked, or active, inactive. The display may also include a timer status for each activated ballot, and this may be the time that has elapsed since the ballot was activated by the poll worker. Embodiments of the present invention may also include a display detailing any vote verification processes currently being reviewed by a voter. This display may indicate whether a voter display screen is, for example, a) displaying a voter's ballot choices, b) awaiting a voter response to a prompted “Verify” or “Do Not Verify”, or c) awaiting a ballot choice “Yes” or “No” decision. The information displayed on the poll worker console is not limited to the above information and may contain other election data relevant or useful to the poll workers.

An embodiment of the present invention may involve the voter taking an assigned ballot to a booth and placing said assigned ballot on an ordinary writing surface in the booth. The procedure may continue with the voter removing a voter digital pen from a voter digital pen docking station. Each voting booth may have a uniquely assigned voter digital pen with a correspondingly unique voter digital pen docking station. The voter digital pen may be used by the voter to mark each election choice. Once the voter has marked all of his/her choices, the voter may replace the voter digital pen back into the voter digital pen docking station, or the voter makes a mark on the ballot within a special box on the ballot indicating they are done voting (when the digital pen detects that a mark has been made in this box, it deactivates the ballot.). Several events may be triggered when the voter digital pen is replaced into the docking station or the voter makes a mark on the ballot within a special box on the ballot indicating they are done voting (when the digital pen detects that a mark has been made in this box, it deactivates the ballot.). These events may include, but are not limited to, the following: a) the status of the ballot may be immediately changed to deactivated and the ballot may not be used or modified ever again, and b) the location of each and every mark made by the voter on the unique paper ballot, as recorded on the voter digital pen, may be transmitted from the pen to a Recognition Engine (which may reside in the Precinct Server). With an extremely high degree of accuracy, the voter's intent may be determined by the Recognition Engine using the data from the voter digital pen combined with the pre-defined dot, or other, pattern/election choice relationship data, for example, the Anoto pattern technology. The Recognition Engine may create an encrypted file (XML or other file type) containing the results (i.e. containing the voter's intended election selections).

At the Precinct Server, the file may be rendered for display and a vote verification display device may be activated to allow the voter to review the electronically re-created voter selections on the display in the voter booth. The vote verification display device may be a touch-screen, flat-panel display, or some other suitable display for electronically presenting and verifying voter selections. The voter may be prompted on the vote verification display as to whether or not the voter would like to verify the selections. This may be done with two selections on the touch-screen that read “VERIFY” or “DO NOT VERIFY” or something similar. The voter may then select the preferred response.

If the voter selects “DO NOT VERIFY”, then the votes may be irrevocably cast at the moment the “DO NOT VERIFY” box is touched on the screen. If the voter selects “VERIFY”, then each page of the ballot may be displayed with the trailing question, “Are these ballot selections correct?” The voter may be given two response selection boxes on the screen that read “YES” or “NO”. If the “YES” box is touched, then the subsequent pages of the ballot may be displayed with the same “YES” and “NO” selection boxes until all choices are verified. Once the last page of the ballot is verified, the votes may be irrevocably cast. If, during any verification process, on any screen the voter touches “NO” signaling that the ballot selections are not correct, the ballot may be immediately and irrevocably “spoiled”. To cast a vote after a ballot has been “spoiled”, the voter may need to obtain a new ballot from a poll worker and begin the voting process again. If the voter leaves the voting booth without answering the prompt on the screen to “Verify” or “Do Not Verify” the selections, the votes may be irrevocably cast once a pre-defined time-out period has elapsed. For example, it may be programmed that 60 seconds after the prompt is displayed, a non-response defaults to the votes being irrevocably cast.

If the voter fails to vote the ballot or changes his or her mind about a ballot choice, the voter may request that a poll worker “spoil” the ballot. The poll worker may be able to perform this task by using a poll worker digital pen and making a line across a Spoiled Ballot box on the ballot. If the voter prematurely docks the voter digital pen (i.e. the voter had not completed marking his or her selections), the voter may select “Verify” to verify the votes and then select “NO” to immediately “spoil” the ballot. Alternatively, the voter may take the incomplete ballot to a poll worker who could “spoil” the ballot for the voter. Once the ballot is “spoiled”, the ballot may not be used to cast a vote. The ballot may be replaced by a poll worker, and the voter may begin the voting process again. (The process may start over with the poll worker using a poll worker digital pen to mark a line across the box or boxes in the ballot authenticator location on the ballot.) To complete the voting process, after completing the verification process the voter may place the ballot back into the privacy sleeve, exit the booth, and deposit the ballot in the ballot box.

It is not uncommon after a close election for the results of an election to be challenged. In this situation, a recount of the votes may be requested. In past elections, votes have been counted two or even three times after an election. An embodiment of the present invention may store every system state change and transaction on multiple storage devices. The votes may be “counted” at the time the voter marks the ballot and re-docks the voter digital pen. The voter digital pen may send the recorded marks and their corresponding locations on the pages of the ballot. The marks and locations of the vote may be transmitted to the Recognition Engine in the Precinct Server. The data may be immediately interpreted into ballot selections by the Recognition Engine and the results may then be stored in an encrypted database. This database may be referred to as the Primary Votes-Cast Database. The results may additionally be stored as an image of the ballot itself. Once all of the votes have been cast for a polling place, the SecureNexus, containing the Primary and Backup Votes-Cast Databases may be sent to a central tabulation location. At the central tabulation location, the votes may be extracted from each SecureNexus (i.e. one for each polling place) and the votes may be added to a database referred to as a Final Vote Database.

An embodiment of the present invention may therefore allow for a recount to be performed using various methods. The SecureNexus may be recounted as many times as deemed necessary. The SecureNexus may retain the votes until it is manually erased. An electronic record may be updated and stored internally on the SecureNexus detailing the identification of the tabulation computer to which the SecureNexus is attached and the number of times it is attached. This and other features of the present invention may allow for a first-level recount to be performed using several different methods. In the first method, the SecureNexus may be reattached to a Tabulation Computer and the Primary Votes-Cast Database may be reprocessed. In the second method, the Recognition Engine may generate a new Votes-Cast Database by reprocessing the original digital pen marks and the ballot locations for each ballot. (This data may be stored in the SecureNexus in the Primary Votes-Cast Database as pen mark location files.) This method may entirely re-create the Votes-Cast Database from the original data sent by the voter digital pen at the time the voter made his or her choices. In a third method, the Precinct Server may be used as it may contain secondary, backup disk drives and a PCI-bus Write-Once, Read-Many device (i.e. a WORM device). These devices may store mirror images of the Primary Votes-Cast Database.

A second-level recount may also be performed in various ways in an embodiment of the present invention. In the first method, the SecureNexus may be reattached to the Tabulation Computer and the Secondary Votes-Cast Database may be reprocessed. In the second method, the Recognition Engine may generate a new Votes-Cast Database by reprocessing the original digital pen marks and the ballot locations for each ballot. (This data may be additionally stored in the SecureNexus in the Secondary Votes-Cast Database as pen mark location files.) This method may entirely re-create the Votes-Cast Database from the secondary copy of the original data sent by the voter digital pen at the time the voter made his or her choices.

A third-level recount may be performed using data from the hard disk of the SecureNexus. Each pen docking station may be connected through a SecureNexus peripheral concentrator physical or wireless device to the Recognition Engine and, ultimately, to the primary and secondary storage devices in the Precinct Server. As the data streams through the SecureNexus, it may also be recorded on the hard disk. These data streams may be used to re-create the complete voting process.

In an embodiment of the present invention, a fourth-level recount may be performed using various methods. In the first method, the ballot image files may be manually reviewed and tallied. In the second method, the actual paper ballots placed in the ballot box by the voters may be validated as having been properly cast and then scanned and tallied by an absentee ballot scanner (which will be described later in this section). In the third method, the actual paper ballots placed in the ballot boxes may be validated as having been properly cast and then manually tallied. Because each ballot has a unique identifier, and because, before each voter cast his or her vote, the unique ballot identifier has been scanned and recorded by the ballot authentication process (described above), paper ballots that have been placed into the ballot boxes to illegally change the vote count (ballot box “stuffing”), can be identified and cast out of the recount process.

An embodiment of the present invention may experience peripheral device difficulties or Precinct Server failure modes during its use in an election. The following recovery methods may be used in an embodiment of the present invention. In the event that a Precinct Server (including the SecureNexus) is rendered inoperable, a poll worker may call a Tech Support person to report the problem. The failure may be detected through system messages on the poll worker console or error messages on the vote verification display. A poll worker may also report an unresponsive or “hung” system or a general A/C power loss at the polling location. Recovery actions may include one, many, or all of the following actions: exchange the poll worker console keyboard with a backup, exchange the poll worker console with a vote verification display from one of the voting booths, and reboot the system. Recovery actions are not limited to these actions. Exchanging the keyboard and/or the console may eliminate the components as a source of the non-responsive system. In an embodiment of the present invention, both the Precinct Server and the SecureNexus may redundantly store the Votes-Cast Database so that no stored data would be lost in the above failure mode. A vote-in-progress at the time of the failure may be lost. Therefore, resulting ballots may be sight verified by the voter and either cast or “spoiled”. Alternatively, resulting ballots may be treated as an emergency paper ballot. Once the issue is resolved, voting may continue in the normal manner.

An embodiment of the present invention may utilize any of the following recovery methods if a failure mode arises regarding the voter digital pen. Due to a variety of reasons, a voter digital pen may be rendered inoperable during an election process. The cause may be a malfunctioning or non-functioning scanner or camera, a loose or faulty connection, or some other failure which causes the digital pen to be rendered inoperable. One method of detecting this failure may be that the Precinct Server detects that no data was transmitted after a voter digital pen was docked. The failure may also be exhibited to the voter if the voter attempts to verify his or her choices and the vote verification display contains incomplete, inaccurate, and/or jumbled selections. Additionally, a system message may appear on the poll worker console. In any case, the voter digital pen may be replaced with a backup voter digital pen. A ballot in process may be “spoiled” by the voter or by a poll worker according to the previously mentioned methods for “spoiling” a ballot. The voter may begin the voting process again with a new ballot. In an embodiment of the present invention, this failure produces no lost votes; and, after recovery, voting may continue in the normal manner.

In a similar failure of a poll worker digital pen, an embodiment of the present invention may utilize any of the following methods. The causes may be the same as those covered with the voter digital pen failure; a failed or malfunctioning scanner or camera, a loose or faulty connection, or some other failure which renders the poll worker digital pen inoperable. The Precinct Server may again detect that no data was sent following the docking of the poll worker pen. Additionally, a system message may appear on the poll worker console. In any case, the poll worker digital pen may be replaced with a backup poll worker digital pen. If necessary, a partially authenticated ballot may be “spoiled” by the poll worker and another ballot retrieved for the awaiting voter. Again, this failure produces no lost votes; and, after recovery, voting may continue in the normal manner.

In another potential peripheral device failure, the vote verification display may become inoperable during an election process. The voter may observe that the vote verification display does not work, and this observation may be brought to the attention of a poll worker. In an embodiment of the present invention, the poll worker may call Tech Support and describe the problem to Tech support. Tech Support may guide the poll worker through discovery and recovery efforts to determine the final course of action. Once the vote verification display is replaced or rendered operable, the verification process may continue. This failure produces no lost votes; and, after recovery, voting may continue in the normal manner.

Another potential peripheral device failure may include the failure of the poll worker console. Any failure that renders the poll worker console inoperable may be detected by a poll worker. The poll worker console may be replaced with a backup poll worker console. This failure produces no lost votes; and, after recovery, the voting may continue in the normal manner.

In an exemplary embodiment, the voter digital pen docking station may become inoperable during an election process. The vote verification screen prompt may not appear for the voter on the vote verification display. A poll worker may detect the failure by detecting that after a voter leaves a voting booth, the voter digital pen was never docked according to the poll worker console. Alternatively, the poll worker console may alert the poll worker once the undocked pen timeout feature has been triggered. If the failure is detected before the voter leaves the polling location, the recovery method may proceed as follows. The involved ballot may be “spoiled” and the voter may be asked to vote again (either using a different booth or using the same booth once the voter digital pen docking station has been replaced). If the failure is detected after the voter leaves the polling location, the recovery method may proceed as follows. The voter digital pen docking station may be replaced, the new voter digital pen docked, and the vote cast. Because the voter left without completing the verification process, the vote may be cast “without verification”. In any case, the votes may remain stored in the voter digital pen until an operable voter digital pen docking station is connected into the system through a physical or wireless connection. This failure produces no lost votes; and, after recovery, the voting may continue in the normal manner.

In an embodiment of the present invention, the SecureNexus peripheral concentrator device may redundantly store state and environmental data to be used in real-time fraud detection. The SecureNexus may be constructed as a “black box” with known inputs and outputs, concealed inner workings, a tamper-aware case, and a processing unit which is implemented in Application Specific Integrated Circuits (ASIC). The SecureMonitor may generate a random value based on the sum of various pre-defined measures at ten-second intervals and time stamps the random value. These pre-defined measures may include, but are not limited to, the system voltage, the device internal temperature, and the ambient external acoustic noise level. The randomly generated values may then be used by other system components to delineate their state changes. This may allow for real-time comparisons between redundantly stored information and a determination if one or more data stores may have been compromised.

In an exemplary embodiment of the present invention, the following procedure may be implemented for the absentee ballot process. The process may be initiated when the voter's request for an absentee ballot arrives at the absentee ballot processing center. The absentee worker may authenticate the voter and determine the correct ballot style. The absentee worker may retrieve the correct ballot and, using the absentee ballot worker digital pen, activate the ballot. Ballot activation may be performed by drawing a line across a special box or boxes printed on the ballot. This area on the ballot may again be referred to as the ballot authenticator location. Ballot activation may be performed with the absentee ballot worker digital pen. The ballot activation may be completed when the absentee ballot worker digital pen is replaced in the absentee ballot worker digital pen docking station. The ballot may then be handed to the voter or mailed to the voter.

Absentee ballot workers may monitor the absentee ballot worker console which may display information about activated absentee ballots. The information displayed may include one or many of the following readings: the number or activated absentee ballots sent to voters, the number of activated absentee ballots that are returned by voters and have been “spoiled”, the number of “spoiled” absentee ballots that are replaced with a new ballot, and the number of activated absentee ballots sent to voters that have not yet been returned. The information displayed should not be limited to this list, and any other information relevant to absentee ballots may also be included. When an absentee ballot is returned to the absentee ballot processing center, absentee ballot workers may authenticate the ballot by touching the ballot with the absentee ballot worker digital pen. The reading from the digital pen may immediately indicate whether the ballot is authentic or not by reading the dot, or other, pattern on the ballot. Alternatively, the pen scanner technology may be added to a scanner and then the scanner may be used for ballot authentication. Authenticated ballots may be mark-sense scanned using a mark-sense scanning device. The results may then be stored as a standard file (XML or other file type), and additionally, an image file of the ballot may be generated from the scanner.

In one embodiment of the present invention, the SecureNexus peripheral concentrator may be comprised of the following features and components. One SecureNexus may be used per polling station. The outer case of the SecureNexus may be sealed and tamper-aware. Multiple docking stations and multiple displays may be supported by the SecureNexus. An exemplary embodiment may include video and USB connectors having each connector numbered, color coded, and uniquely shape-matched for quick and accurate set-up. The SecureNexus may contain a transaction memory location for storing information such as encrypted pen mark location files, environment variables, clock data, and countdown data. For added security and identification purposes, the SecureNexus may contain a self-powered countdown clock that may not be altered throughout the entire election process. The countdown clock may be zeroed at the start of an election once and it may not be altered again.

In an exemplary embodiment, the Precinct Server may run from a hardened, secure Operating System (such as Linux). The Precinct Server may be fully compliant the Oasis Election and Voter Services Technical Committee Election Markup Language (EML) standard or the most current version of said standard. The poll worker console may be connected to the Precinct Server or a secure wireless connection may be used. The SecureNexus may contain multiple storage devices. The storage devices may include, but are not limited to, a WORM (write-once, read-many) storage device, flash memory, and hard disk drives. The storage devices may store tallied votes, pen mark location files, or other necessary election information.

An exemplary embodiment of the present invention may utilize a SecureCount Tabulation Server to tabulate votes from multiple polling locations or precincts. The SecureCount Tabulation Server may fully comply with Version 4.0 of the Oasis Election and Voter Services Technical Committee Election Markup Language (EML) standard. The data input to the SecureCount Tabulation Server may be secure, encrypted data in the format required by the EML standard. The data may be input via a secure network connection or using a physical connector to the memory devices. In an exemplary embodiment, the SecureCount Tabulation Server may receive the following input: encrypted EML files (eEML files) and eMetadata (containing, for example, precinct vote counts, error reports, reconciliation reports, and environmental variables). The output from the SecureVote Tabulation Server may include, but is not limited to, tabulated votes, statistics, alerts for fraud, and reconciliation data to ensure that the votes in each precinct have been counted.

The Precinct Server, in an exemplary embodiment, may log critical events and state changes in its event log. Examples of data generated by the Precinct Server include, but are not limited to, system startup and boot data, individual login information, file access information, ballot selections, eMetadata, verification display prompts, ballot status (i.e. “cast” or “spoiled”), Primary Data Storage, and Redundant Data Storage. In addition, the Precinct Server may capture and log external data such as events forwarded from the SecureNexus.

The SecureNexus peripheral concentrator device may log all of the events and state changes in its event log. The data generated by the SecureNexus may include the universal clock, startup time, connection status, and environmental data. There may also be external data that is captured by the SecureNexus such as the status of any peripheral devices including, but not limited to, digital pen docking stations, displays, consoles, etc. In an embodiment of the present invention, the SecureNexus peripheral concentrator device may log all SecureVote-generated events and state changes the moment the digital pen is docked. For example, docking a voter digital pen may initiate the transfer through a physical or wireless connection of any of the following data (though not restricted solely to the data in this list): unique voter digital pen ID, voter digital pen status, calendar date and time, universal clock time, ballot dot, or other, pattern unique ID, ballot status (i.e. cast or “spoiled”), and pen mark location files. In another example, docking a poll worker digital pen may initiate the transfer through a physical or wireless connection of any of the following data (though not restricted solely to the data in this list): unique poll worker digital pen ID, ballot dot, or other, pattern unique ID, universal clock time, poll worker's activation of ballot, and ballot spoliation. In addition to logging the events and state changes generated from the digital pens, the SecureNexus peripheral concentrator device may log data transmitted from the vote verification display. In an exemplary embodiment, this data would contain voter selections of “Verify”, “Do Not Verify”, “Page OK”, “Page Not OK”, and ballot status (i.e. cast or “spoiled”).

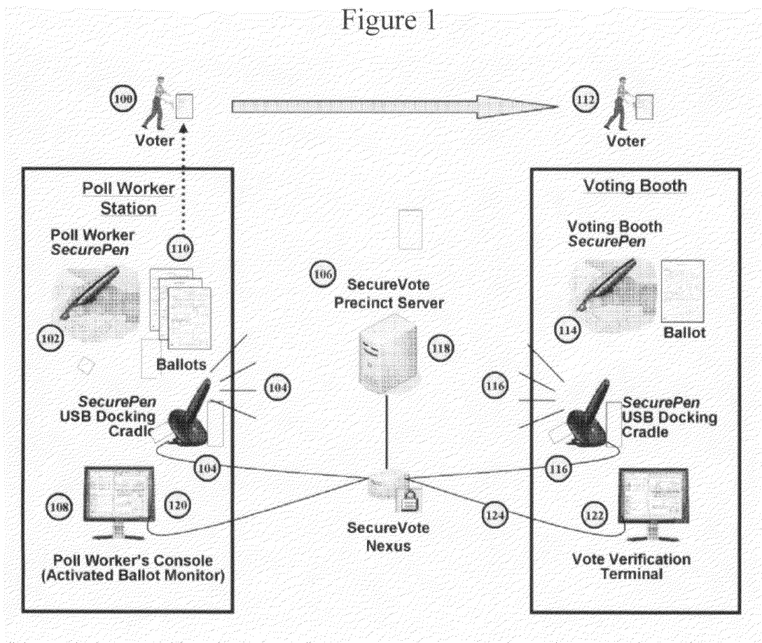

Referring to FIG. 1, the voting process is initiated by a voter or poll worker (100). The poll worker activates the ballot by marking the ballot with the poll worker's digital pen (102). Upon marking the ballot, the poll worker's digital pen reads the unique pattern printed onto the ballot, and from that unique pattern, identifies the unique ballot ID. The unique ballot ID is transmitted from the poll worker's pen to the precinct server through a physical or wireless connection (104) which completes the ballot activation transaction on the precinct server (106). The SecureNexus permanently records every bit of data sent to and from the precinct server. The poll worker's console (108) shows that the ballot has been activated. The ballot is given to the voter (110). The voter takes the ballot to the voting booth (112). The voter fills-out the ballot by marking the ballot with the voting booth digital pen by making physical ink markings onto the ballot (114). The voting booth digital pen records the location of the pen marks, and when the voter is done marking the ballot, the digital pen transmits the pen mark location data to the precinct server via either a wired docking station, or via wireless transmission (116). This action deactivates the ballot on the precinct server (118). The SecureNexus permanently records every bit of data sent to and from the precinct server. The Precinct Server maps the pen mark location data onto an image template of the ballot. The resulting image is an exact digital copy of the completed ballot. The Precinct Server Recognition Engine reads the pen mark location data and the voter's ballot selections in a secure file (XML or other file type) (118). The poll worker's console reflects that the ballot has been deactivated (120). The vote verification terminal in the voting booth displays the voter's selections side-by-side, page-by-page with an image of the completed ballot (122). The voter may confirm the correctness of their selections by using a touch screen or input device that allows the voter to confirm or deny the correctness (122). Once confirmed, the voter input file transaction is cast on the precinct server (124). A voting booth status file may be automatically generated during voting from a voter station by the SecureNexus. This file may include, for example, duration that the digital pen was removed from the docking station, status of various components during the voting, or the times and sequence of various actions taken during the voting process. The voting booth status file may be stored locally and/or transmitted through a physical or wireless connection to the precinct server for safe storage. The voting process is completed and the voting booth may be prepared for the next voter. This process collects and redundantly stores multiple data streams that can be used for real time or ex post tampering detection. This process provides multiple records from multiple perspectives that can be used to detect and prevent tampering of the system or ensure accuracy of the voting process.

After the polls close, all the ballots, both spoiled and validated, may be collected. At the central tabulation center, these ballots may be scanned. The scanning may be done in bulk with scanner/digital pen combination that scans the document while simultaneously reading the unique dot pattern of the ballot. This may provide additional reconciliation between the data files stored on the SecureNexus device and voters hand-marked paper ballots. In addition it may be possible to determine ballot overcounts and undercounts by comparing the two sets of data. This method may help ensure a more reliable election than present techniques allow.

Once the polls close, the SecureNexus device may be transported to the central tabulation center. There multiple, unique data sets may be extracted under secure conditions. A series of multivariate statistical analyses may be run to determine the probability of fraudulent voting activities having occurred. These analyses may detect anomalies in the environmental data collected by the SecureNexus device and may detect differences in the data sets. In addition, the SecureNexus device may be able to report tampering attempts and if it has been physically moved.

According to one exemplary embodiment, a voting system may have a pattern identifier, pre-printed onto all ballots. The pattern may have a pattern that is unique for each and every ballot. The pattern may uniquely identify the ballot type and which uniquely identifies and differentiates one instance of a ballot from another instance of the said ballot. The pattern may contain an encoded unique identification number that uniquely identifies the instance of the said ballot. The unique pattern may provide a unique voting system functionality that may allow the poll workers' digital pens and the voters' digital pens to record the location of all respective marks made with the pens onto the ballot. The unique pattern may provide a unique voting system functionality that may allow the poll workers' digital pens and the voters' digital pens to record the unique patter ID of a ballot upon marking the ballot with the pens. The unique pattern of may provide a unique voting system functionality that may allow the voting system to immediately identify any duplicated or copied ballots, to immediately identify any legitimate ballots from other polling locations, alert the poll workers if said conditions exist, and flag the ballot as possibly fraudulent. This would detect attempts to “stuff the ballot box”. The unique pattern may provide a unique voting system functionality that may allow the voting system to mark a ballot as ACTIVATED upon marking the ballot with the poll worker's pen. The unique pattern may provide a unique voting system functionality that may allow the voter's digital pen to identify the unique pattern ID of the ballot in order to update the voting system to reflect the booth number in which the voter has taken the ballot to vote. The unique pattern may provide a unique voting system functionality that may allow the Election Authority to authenticate the absentee paper ballots against the Absentee Ballot Database by marking the received absentee ballots with a digital pen. The voting system may then record the ballot unique ID and mark the ballot as DEACTIVATED. The unique pattern may provide a unique voting system functionality that may allow the Election Authority to scan all ballots in bulk with a document-scanner/digital-pen combination that scans the document (to create a digital image of the document) while simultaneously reading the unique dot pattern of the ballot in order to then authenticate the absentee paper ballots against the Absentee Ballot Database in order to detect attempts to “stuff the ballot box”.

According to one exemplary embodiment, the digital computing & storage device may redundantly store system state, environmental, and voting metadata to be used in ex-post voting fraud detection. Fraud-detection algorithms may be invoked by the Election Authority and notification, in the form of multiple reports containing privileged and public information, is given if there are any indicators of fraudulent voting activities. SecureNexus stores the resultant data sets on a Write-Once-Read-Many (WORM) device. A unique pattern may provide a unique voting system functionality that may allow the Election Authority to scan in bulk with scanner/digital pen combination that scans the document while simultaneously reading the unique dot pattern of the ballot. This may provide additional reconciliation between the image created by the document scanner and the image created by the digital pen. The digital computing & storage device may redundantly store system state, environmental, and voting metadata to be used in SecureNexus tampering detection. The tamper-detection algorithms, invoked by the Election Authority, use, but are not limited to, accelerometer, acoustic, power, and GPS data, and voting metadata, and give notification, in the form of multiple reports containing privileged and public information, if there are any indicators of SecureNexus tampering activities. SecureNexus stores the resultant data sets on a Write-Once-Read-Many (WORM) device. The Election Authority may scan the ballot with a digital pen and its unique ballot identifier is validated against the Consolidated Ballot Database. Authenticated ballots may then be processed by a standard mark-sense scanning system. The voter's selections are interpreted and added to the Recount Votes-Cast Database.

Modifications and substitutions by one of ordinary skill in the art are considered to be within the scope of the present invention, which is not to be limited except by the following claims.

What is claimed is:

1. A voting system comprising:
a paper ballot form for an election that has a printed pattern that uniquely identifies said paper ballot from other paper ballots in the election and a voter digital pen having a physical marker for producing a physical mark on the paper ballot form, a unique identification number which uniquely identifies said digital pen, an optical imaging device for reading the exact location of each and every physical mark made by said physical maker on the paper ballot form along with reading the unique identifier pattern from the paper ballot form, a digital memory for recording information read by the optical imaging device, and a transmitter for transmitting the record information to a digital computing device.

2. The voting system of claim 1, wherein the printed pattern is a printed dot pattern based on the Anoto pattern technology

3. A voting system of claim 1, further comprising:
an image conversion means for interpreting and converting the transmitted information into a digital image of the paper ballot form along with each and every mark that was made on the paper ballot form and store the digital image in a database;
a choice conversion means for interpreting and converting the transmitted information into digital information of one or more choices marked on the paper ballot form and store said digital information in the database.

4. The voting system of claim 1, further comprising:
a poll worker digital pen having an optical imaging device for reading the unique identifier pattern from the paper ballot form and a database for storing the unique identifier pattern as associated with a paper ballot form having a status.

5. The voting station of claim 4 wherein after the voter digital pen sends the unique identifier pattern to the digital computing device and the digital computing device associates a status of the paper ballot form.

6. A digital computing & storage device at each polling place, comprising:
a poll worker station with a poll work digital pen;
a voting booth with a voting booth digital pen;
at least one nexus device for processing status information between the poll worker station and voting booth;
at least two storage devices with different storage technologies each storage device recording all system state information including information processed by the nexus device.

7. The digital computing & storage device of claim 6, further comprising:
a consolidated votes-cast database for storing and extracting votes from each nexus device.

8. The digital computing & storage device of claim 6, wherein the nexus device generates and records system state information while votes are in-transit from the voting booth to the consolidated votes-cast database.

9. The digital computing & storage device of claim 6, wherein, a recount extracts information from the nexus device and uses status information.

10. The digital computing & storage device of claim 6, may redundantly store system state, environmental, and voting metadata to be used in real-time fraud detection.

11. The digital computing & storage device of claim 6, wherein the nexus devices operates using an Application Specific Integrated Circuit (ASIC).

12. The digital computing & storage device of claim 6, wherein the nexus devices provides real-time comparisons between redundantly stored information to determine if a storage device has been compromised.

13. The digital computing & storage device of claim 11, wherein the nexus device detects the use of unauthorized equipment and unauthorized paper ballots.

14. A precinct monitoring equipment comprising:
one or more voter monitoring devices for detecting a status of ballots currently in use within a voting precinct, a status of all voter terminals within the voting precinct, a status of each voter digital pen within the voting precinct, a status of the transmission of pen strokes from each voter digital pen to a precinct server within the voting precinct, and a status of the transmission of pen strokes from each poll worker's digital pen to the precinct server; and
a computer monitor viewed by the poll workers and displaying the status detected by the one or more voter monitoring devices.

15. A precinct monitoring equipment of claim 14, wherein the status of ballots include: activation of ballot, deactivation of ballot, ballot spoiled, vote cast and ballot deactivated.

16. A precinct monitoring equipment of claim 14, further comprising:
one or more monitoring devices for detecting a unique ballot ID encoded in a unique pattern of a ballot.

17. A precinct monitoring equipment of claim 14, further comprising:
one or more monitoring devices for detecting a voting booth number and a unique ID of a poll worker digital pen used to activate a ballot

18. A precinct monitoring equipment of claim 14, further comprising:
one or more monitoring devices for detecting a period of time elapsed between changes to the ballot status and a time and date of each status ballot status change.

19. A precinct monitoring equipment of claim 14, further comprising:
one or more monitoring devices for detecting a unique ID of a voter digital pen.

20. A precinct monitoring equipment of claim 16, wherein the unique pattern of the ballot is a printed dot pattern based on the Anoto pattern technology.
